(19) United States
(12) Patent Application Publication
(10) Pub. No.: US 2008/0204238 A1
(43) Pub. Date: Aug. 28, 2008

(54) Method to RFID enable electronic devices

(75) Inventor: Joseph White, Woodbine, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/711,687

(22) Filed: Feb. 28, 2007

(51) Int. Cl. G08B 13/14

(52) U.S. Cl. 340/572.1

(57) ABSTRACT

Methods, systems, and apparatuses for radio frequency identification (RFID) enabled devices, are described herein. In an aspect, a method of assembling an RFID enabled device includes providing an antenna on a surface of a substrate, providing a land pattern for an electrical circuit, and mounting the electrical circuit on the substrate, wherein the electrical circuit is electrically isolated from the antenna.

### BACKGROUND OF THE INVENTION

1. Field of the Invention

The invention relates to radio frequency identification (RFID) technology, and in particular, to identification of electrical devices.

2. Background Art

Radio frequency identification (RFID) tags are electronic devices that may be affixed to items whose presence is to be detected and/or monitored. The presence of an RFID tag, and therefore the presence of the item to which the tag is affixed, may be checked and monitored wirelessly by devices known as “readers.” Readers typically have one or more antennas transmitting radio frequency signals to which tags respond. Since the reader “interrogates” RFID tags, and receives signals back from the tags in response to the interrogation, the reader is sometimes termed as “reader interrogator” or simply “interrogator”.

With the maturation of RFID technology, efficient communication between tags and interrogators has become a key enabler in supply chain management, especially in manufacturing, shipping, and retail industries, as well as in building security installations, healthcare facilities, libraries, airports, warehouses etc.

RFID tags are also used to monitor various types of electronic devices such as computer accessories. Source tagging these types of devices is often inefficient and costly because RFID tags may have to be customized for each type of device surface.

Thus what is needed is an efficient way of source tagging electrical devices that can be used with a variety of different types of devices and can be manufactured inexpensively.

### BRIEF SUMMARY OF THE INVENTION

Methods, systems, and apparatuses for radio frequency identification (RFID) enabled devices are described herein. Assembly of tags as described herein allows for low-cost source tagging of electrical devices.

In a first aspect, a method of assembling an RFID enabled device includes providing an antenna on a surface of a substrate, providing a land pattern for an electrical circuit, and mounting the electrical circuit on the substrate. The electrical circuit is electrically isolated from the antenna.

In a further aspect, the substrate, the antenna, and the electrical circuit are enclosed in an enclosure.

In another aspect, an RFID enabled device includes a substrate, an antenna, and an electrical circuit mounted on the substrate. The electrical circuit is electrically isolated from the first electrical circuit and the antenna.

In a further aspect, the device also includes an enclosure that encloses the substrate, the antenna, and the electrical circuit.

In another aspect, a method of communicating with an RFID enabled device includes storing an identification code, receiving an RFID interrogation at an antenna of the device, generating a response using to the RFID interrogation signal, performing a function in an electrical circuit mounted to the substrate, and transmitting the response. The response includes the identification code. The electrical circuit is electrically isolated from the antenna.

These and other advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an environment where radio frequency identification (RFID) readers communicate with an exemplary population of RFID tags.

FIG. 2 shows a block diagram of receiver and transmitter portions of a RFID reader.

FIG. 3 shows a block diagram of an example RFID tag.

FIGS. 4A-4B show top views of an RFID enabled device, according to an embodiment of the present invention.

FIGS. 5A-5B show top and side cross-sectional views respectively of another RFID enabled device, according to an embodiment of the present invention.

FIG. 6 shows a flowchart providing example steps for assembling an RFID enabled device, according to an example embodiment of the present invention.

FIGS. 7A-7B show an RFID enabled device at different stages of assembly, according to an embodiment of the present invention.

FIGS. 8-11 provide additional optional steps for the flowchart of FIG. 6, according to example embodiments of the present invention.

FIG. 12 shows a flowchart providing example steps for communicating with an RFID enabled device, according to an example embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Furthermore, it should be understood that spatial descriptions (e.g., “above,” “below,” “up,” “down,” “top,” “bottom,” “vertical,” “horizontal,” etc.) used herein are for purposes of illustration only, and that practical implementations of the structures described herein can be spatially arranged in any orientation or manner.

### Example RFID System Embodiment

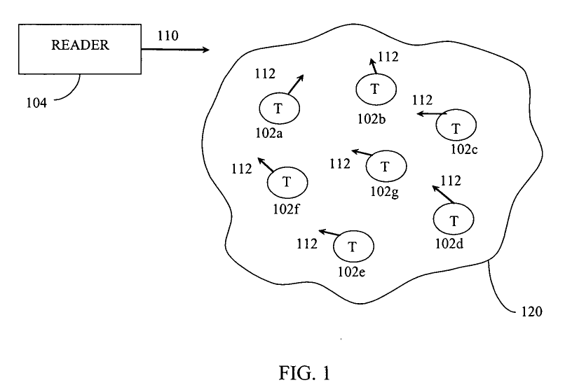

Before describing embodiments of the present invention in detail, it is helpful to describe an example RFID communications environment in which the invention may be implemented. FIG. 1 illustrates an environment 100 where a RFID tag reader 104 communicates with an exemplary population 120 of RFID tags 102. As shown in FIG. 1, the population 120 of tags includes seven tags 102a-102g. A population 120 may include any number of tags 102.

Environment 100 includes one or more readers 104. A reader 104 may be requested by an external application to address the population of tags 120. Alternatively, reader 104 may have internal logic that initiates communication, or may have a trigger mechanism that an operator of reader 104 uses to initiate communication.

As shown in FIG. 1, reader 104 transmits an interrogation signal 110 having a carrier frequency to the population of tags 120. Reader 104 operates in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency. This technique for alternatively absorbing and reflecting signal 110 is referred to herein as backscatter modulation. Readers 104 receive and obtain data from response signals 112, such as an identification number of the responding tag 102. In the embodiments described herein, a reader may be capable of communicating with tags 102 according to any suitable communication protocol, including binary traversal protocols, slotted aloha protocols, Class 0, Class 1, EPC Gen 2, any others mentioned elsewhere herein, and future communication protocols.

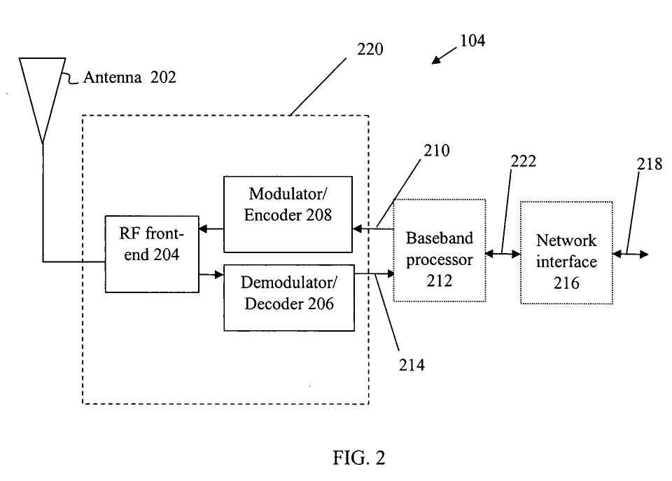

FIG. 2 shows a block diagram of an example RFID reader 104. Reader 104 includes one or more antennas 202, a receiver and transmitter portion 220 (also referred to as transceiver 220), a baseband processor 212, and a network interface 216. These components of reader 104 may include software, hardware, and/or firmware, or any combination thereof, for performing their functions.

Baseband processor 212 and network interface 216 are optionally present in reader 104. Baseband processor 212 may be present in reader 104, or may be located remote from reader 104. For example, in an embodiment, network interface 216 may be present in reader 104, to communicate between transceiver portion 220 and a remote server that includes baseband processor 212. When baseband processor 212 is present in reader 104, network interface 216 may be optionally present to communicate between baseband processor 212 and a remote server. In another embodiment, network interface 216 is not present in reader 104.

In an embodiment, reader 104 includes network interface 216 to interface reader 104 with a communications network 218. As shown in FIG. 2, baseband processor 212 and network interface 216 communicate with each other via a communication link 222. Network interface 216 is used to provide an interrogation request 210 to transceiver portion 220 (optionally through baseband processor 212), which may be received from a remote server coupled to communications network 218. Baseband processor 212 optionally processes the data of interrogation request 210 prior to being sent to transceiver portion 220. Transceiver 220 transmits the interrogation request via antenna 202.

Reader 104 has at least one antenna 202 for communicating with tags 102 and/or other readers 104. Antenna(s) 202 may be any type of reader antenna known to persons skilled in the relevant art(s), including a vertical, dipole, loop, Yagi-Uda, slot, or patch antenna type. For description of an example antenna suitable for reader 104, refer to U.S. Ser. No. 11/265,143, filed Nov. 3, 2005, titled “Low Return Loss Rugged RFID Antenna,” now pending, which is incorporated by reference herein in its entirety.

Transceiver 220 receives a tag response via antenna 202. Transceiver 220 outputs a decoded data signal 214 generated from the tag response. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network 218.

In embodiments, network interface 216 enables a wired and/or wireless connection with communications network 218. For example, network interface 216 may enable a wireless local area network (WLAN) link (including a IEEE 802.11 WLAN standard link), a BLUETOOTH link, and/or other types of wireless communication links. Communications network 218 may be a local area network (LAN), a wide area network (WAN) (e.g., the Internet), and/or a personal area network (PAN).

In embodiments, a variety of mechanisms may be used to initiate an interrogation request by reader 104. For example, an interrogation request may be initiated by a remote computer system/server that communicates with reader 104 over communications network 218. Alternatively, reader 104 may include a finger-trigger mechanism, a keyboard, a graphical user interface (GUI), and/or a voice activated mechanism with which a user of reader 104 may interact to initiate an interrogation by reader 104.

In the example of FIG. 2, transceiver portion 220 includes a RF front-end 204, a demodulator/decoder 206, and a modulator/encoder 208. These components of transceiver 220 may include software, hardware, and/or firmware, or any combination thereof, for performing their functions. Example description of these components is provided as follows.

Modulator/encoder 208 receives interrogation request 210, and is coupled to an input of RF front-end 204. Modulator/encoder 208 encodes interrogation request 210 into a signal format, modulates the encoded signal, and outputs the modulated encoded interrogation signal to RF front-end 204. For example, pulse-interval encoding (PIE) may be used in a Gen 2 embodiment. Furthermore, double sideband amplitude shift keying (DSB-ASK), single sideband amplitude shift keying (SSB-ASK), or phase-reversal amplitude shift keying (PR-ASK) modulation schemes may be used in a Gen 2 embodiment. Note that in an embodiment, baseband processor 212 may alternatively perform the encoding function of modulator/encoder 208.

RF front-end 204 may include one or more antenna matching elements, amplifiers, filters, an echo-cancellation unit, a down-converter, and/or an up-converter. RF front-end 204 receives a modulated encoded interrogation signal from modulator/encoder 208, up-converts (if necessary) the interrogation signal, and transmits the interrogation signal to antenna 202 to be radiated. Furthermore, RF front-end 204 receives a tag response signal through antenna 202 and down-converts (if necessary) the response signal to a frequency range amenable to further signal processing.

Demodulator/decoder 206 is coupled to an output of RF front-end 204, receiving a modulated tag response signal from RF front-end 204. In an EPC Gen 2 protocol environment, for example, the received modulated tag response signal may have been modulated according to amplitude shift keying (ASK) or phase shift keying (PSK) modulation techniques. Demodulator/decoder 206 demodulates the tag response signal. For example, the tag response signal may include backscattered data formatted according to FM0 or Miller encoding formats in an EPC Gen 2 embodiment. Demodulator/decoder 206 outputs decoded data signal 214. Note that in an embodiment, baseband processor 212 may alternatively perform the decoding function of demodulator/decoder 206.

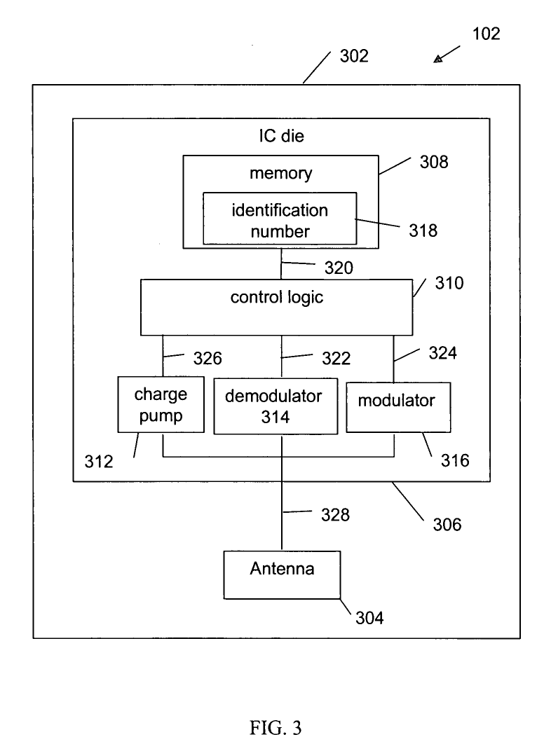

The present invention is applicable to any type of RFID tag. FIG. 3 shows a plan view of an example radio frequency identification (RFID) tag 102. Tag 102 includes a substrate 302, an antenna 304, and an integrated circuit (IC) 306. Antenna 304 is formed on a surface of substrate 302. Antenna 304 may include any number of one, two, or more separate antennas of any suitable antenna type, including dipole, loop, slot, or patch antenna type. IC 306 includes one or more integrated circuit chips/dies, and can include other electronic circuitry. IC 306 is attached to substrate 302, and is coupled to antenna 304. IC 306 may be attached to substrate 302 in a recessed and/or non-recessed location.

IC 306 controls operation of tag 102, and transmits signals to, and receives signals from RFID readers using antenna 304. In the example embodiment of FIG. 3, IC 306 includes a memory 308, a control logic 310, a charge pump 312, a demodulator 314, and a modulator 316. An input of charge pump 312, an input of demodulator 314, and an output of modulator 316 are coupled to antenna 304 by antenna signal 328. Note that in the present disclosure, the terms “lead” and “signal” may be used interchangeably to denote the connection between elements or the signal flowing on that connection.

Memory 308 is typically a non-volatile memory, but can alternatively be a volatile memory, such as a DRAM. Memory 308 stores data, including an identification number 318. Identification number 318 typically is a unique identifier (at least in a local environment) for tag 102. For instance, when tag 102 is interrogated by a reader (e.g., receives interrogation signal 110 shown in FIG. 1), tag 102 may respond with identification number 318 to identify itself. Identification number 318 may be used by a computer system to associate tag 102 with its particular associated object/item.

Demodulator 314 is coupled to antenna 304 by antenna signal 328. Demodulator 314 demodulates a radio frequency communication signal (e.g., interrogation signal 110) on antenna signal 328 received from a reader by antenna 304. Control logic 310 receives demodulated data of the radio frequency communication signal from demodulator 314 on input signal 322. Control logic 310 controls the operation of RFID tag 102, based on internal logic, the information received from demodulator 314, and the contents of memory 308. For example, control logic 310 accesses memory 308 via a bus 320 to determine whether tag 102 is to transmit a logical “1” or a logical “0” (of identification number 318) in response to a reader interrogation. Control logic 310 outputs data to be transmitted to a reader (e.g., response signal 112) onto an output signal 324. Control logic 310 may include software, firmware, and/or hardware, or any combination thereof. For example, control logic 310 may include digital circuitry, such as logic gates, and may be configured as a state machine in an embodiment.

Modulator 316 is coupled to antenna 304 by antenna signal 328, and receives output signal 324 from control logic 310. Modulator 316 modulates data of output signal 324 (e.g., one or more bits of identification number 318) onto a radio frequency signal (e.g., a carrier signal transmitted by reader 104) received via antenna 304. The modulated radio frequency signal is response signal 112, which is received by reader 104. In an embodiment, modulator 316 includes a switch, such as a single pole, single throw (SPST) switch. The switch changes the return loss of antenna 304. The return loss may be changed in any of a variety of ways. For example, the RF voltage at antenna 304 when the switch is in an “on” state may be set lower than the RF voltage at antenna 304 when the switch is in an “off” state by a predetermined percentage (e.g., 30 percent). This may be accomplished by any of a variety of methods known to persons skilled in the relevant art(s).

Modulator 316 and demodulator 314 may be referred to collectively as a “transceiver” of tag 102.

Charge pump 312 is coupled to antenna 304 by antenna signal 328. Charge pump 312 receives a radio frequency communication signal (e.g., a carrier signal transmitted by reader 104) from antenna 304, and generates a direct current (DC) voltage level that is output on a tag power signal 326. Tag power signal 326 is used to power circuits of IC die 306, including control logic 320.

In an embodiment, charge pump 312 rectifies the radio frequency communication signal of antenna signal 328 to create a voltage level. Furthermore, charge pump 312 increases the created voltage level to a level sufficient to power circuits of IC die 306. Charge pump 312 may also include a regulator to stabilize the voltage of tag power signal 326. Charge pump 312 may be configured in any suitable way known to persons skilled in the relevant art(s). For description of an example charge pump applicable to tag 102, refer to U.S. Pat. No. 6,734,797, titled “Identification Tag Utilizing Charge Pumps for Voltage Supply Generation and Data Recovery,” which is incorporated by reference herein in its entirety. Alternative circuits for generating power in a tag are also applicable to embodiments of the present invention.

It will be recognized by persons skilled in the relevant art(s) that tag 102 may include any number of modulators, demodulators, charge pumps, and antennas. Tag 102 may additionally include further elements, including an impedance matching network and/or other circuitry. Embodiments of the present invention may be implemented in tag 102, and in other types of tags.

Embodiments described herein are applicable to all forms of tags, including tag “inlays” and “labels.” A “tag inlay” or “inlay” is defined as an assembled RFID device that generally includes an integrated circuit chip (and/or other electronic circuit) and antenna formed on a substrate, and is configured to respond to interrogations. A “tag label” or “label” is generally defined as an inlay that has been attached to a pressure sensitive adhesive (PSA) construction, or has been laminated, and cut and stacked for application. Another example form of a “tag” is a tag inlay that has been attached to another surface, or between surfaces, such as paper, cardboard, etc., for attachment to an object to be tracked, such as an article of clothing, etc.

Example embodiments of the present invention are described in further detail below. Such embodiments may be implemented in the environments, readers, and tags described above, and/or in alternative environments and alternative RFID devices.

### EXAMPLE EMBODIMENTS FOR RFID ENABLED ELECTRICAL DEVICES

Methods, systems, and apparatuses for radio frequency identification RFID enabled devices are presented. In an embodiment, a method of assembling an electrical device includes applying an electrically conductive material to portions of a surface of a substrate and mounting electrical components on the substrate. The electrically conductive material forms an antenna and at least one PCB land pattern. The antenna is configured to transmit and receive RFID interrogation signals. The electrical device may be one of a variety of types of electrical devices such as a computer, a media player, a mobile communication device (e.g., a cellular phone), or an element of a device such as a hard drive of a computer or an electronic chip. In such an embodiment, source tagging of the electrical device takes place during the assembly of the item.

The example embodiments described herein are provided for illustrative purposes, and are not limiting. The examples described herein may be adapted to any type of electrical device. Further structural and operational embodiments, including modifications/alterations, will become apparent to persons skilled in the relevant art(s) from the teachings herein.

RFID enabled devices refer to devices that perform a function or a set of functions (e.g., a mathematical calculation, play music, etc.) and are additionally enabled with separate ability to respond to RFID interrogation signals. RFID enabled devices according to the present invention are discussed in further detail below.

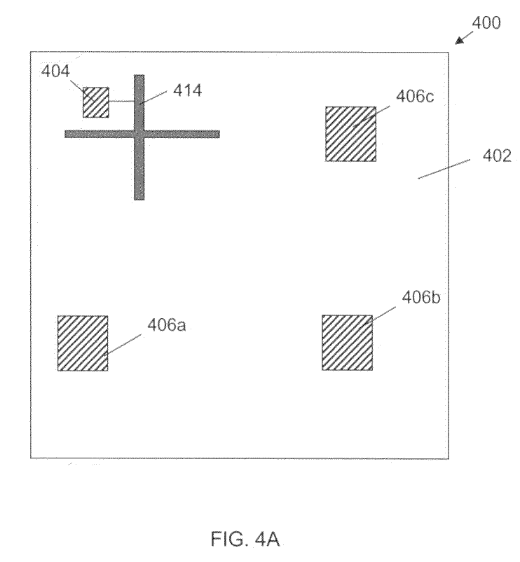

FIG. 4A shows a top view of an RFID enabled device 400, according to an embodiment of the present invention. Device 400 includes a substrate 402, first electrical circuit 404, an antenna 414, a second electrical circuit 406a, a third electrical circuit 406b, and a fourth electrical circuit 406c. Substrate 402 may be a variety of different types of substrates such as a flex-tape substrate or resin materials such as FR-4, as would be understood by someone skilled in the relevant art(s). First electrical circuit 404 is configured with RFID functionality similar to IC 306 described above. First electrical circuit 404 stores an identification code. The identification code may identify aspects of device 400 and/or provide other identifying information. First electrical circuit 404 is configured to provide a response to an RFID interrogation signal. The response includes the identification code. The RFID interrogation signal is be received by antenna 414 formed on substrate 402.

Antenna 414 is electrically coupled to first electrical circuit 404. In an embodiment, antenna 414 is configured to operate as a dual dipole antenna. In alternate embodiments, antenna 414 may be configured to operate as other antenna types such as a dipole antenna, loop antenna, or a patch antenna. Antenna 414 may be configured to transmit response signals generated by first electrical circuit 404, similarly to antenna 304 described above. Antenna 414, as shown in FIG. 4A, is formed by applying electrically conductive material on to substrate 402. However, in alternate embodiments, antenna 414 may be included within an integrated circuit package, such as a dual in-line package, ball-grid array, etc., and mounted, or otherwise attached, to substrate 402. In a further embodiment, first electrical circuit 404 may also be included in such an integrated circuit package.

Device 400 also includes electrical circuits 406. Electrical circuits 406 may include a variety of electrical components and/or devices. In an embodiment, electrical circuits 406 may include surface mount devices, leaded devices, microprocessors, memory, etc. Electrical circuits 406 are electrically isolated from first electrical circuit 404 and antenna 414. In an embodiment where electrical circuit 404 does not provide its own power (e.g., via a charge pump), electrical circuit 404 may be coupled to a power signal of electrical circuits 406.

FIG. 4B shows a top view of an example electrical device 408, according to another embodiment of present invention. In FIG. 4B, substrate 402 is shown as being a printed circuit board (PCB) in which components are electrically coupled together using electrical traces. As shown in FIG. 4B, electrical circuit 404 is electrically coupled to antenna 414 through an electrical trace 410a. Alternatively, electrical circuit 404 may be mounted on antenna 414. Electrical circuits 406 are coupled to each other through electrical traces 410. Electrical traces 410 are an electrically conductive material such as copper or aluminum. Electrical circuits 406 are shown as surface mount components mounted on land pads 412.

FIG. 4B also shows antenna 414 as being a combination of an electrical trace 410b and an electrical trace 410c. Similar to FIG. 4A, antenna 414 in FIG. 4B is configured to operate as a dual dipole antenna, but may be configured to operate as another antenna type as would be understood by persons skilled in the relevant art(s).

FIG. 4B shows electrical circuits 406 electrically coupled using electrical traces. However, in alternate embodiments, electrical circuits may also be coupled through a combination of vias and electrical traces or any other electrical coupling way, as would be understood by persons skilled in the relevant art(s).

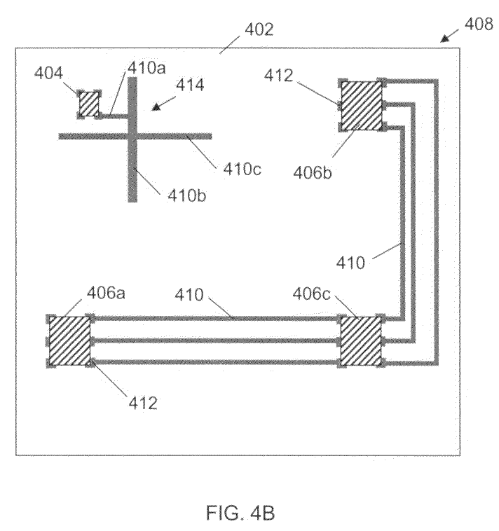

FIG. 5A shows a top cross-sectional view of a device 500, according to an embodiment of the present invention. Device 500 includes device 408 as shown in FIG. 4B and an enclosure 502 that encloses device 408. Enclosure 502 may be made of materials that are transparent to RF electromagnetic waves such as plastics. Enclosure 502 may serve to protect device 408 from environmental conditions.

FIG. 5B shows a side cross-sectional view of device 500. As shown in FIG. 5B, enclosure 502 encloses device 408 from all directions. In alternate embodiments, portions of device 408 may be left exposed by enclosure 502. FIGS. 5A and 5B show enclosure 502 as being substantially rectangular. However, in alternate embodiments, enclosure 502 may be curved or have other shapes such as would be understood by persons skilled in the relevant art(s).

The devices shown in FIGS. 4A-5A each show three electrical devices 406. In alternate embodiments, however, any number of electrical circuits may be present performing any number of functions.

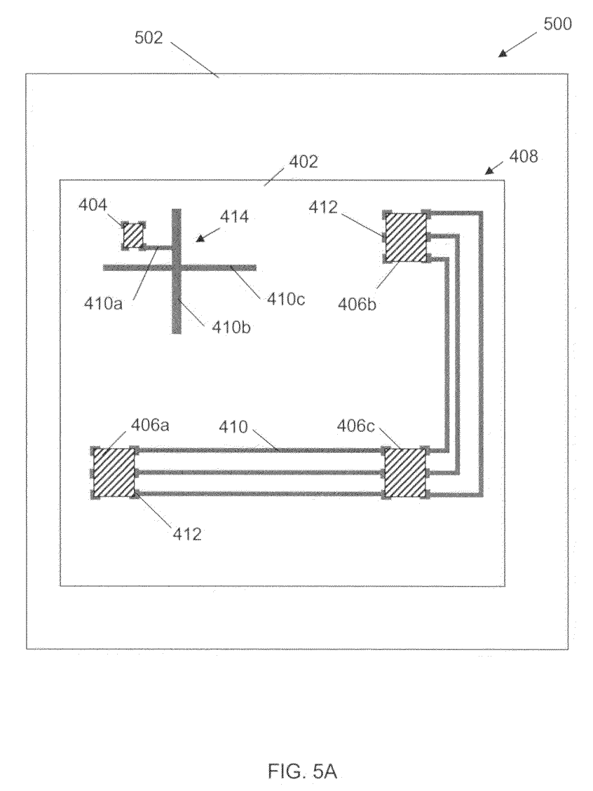

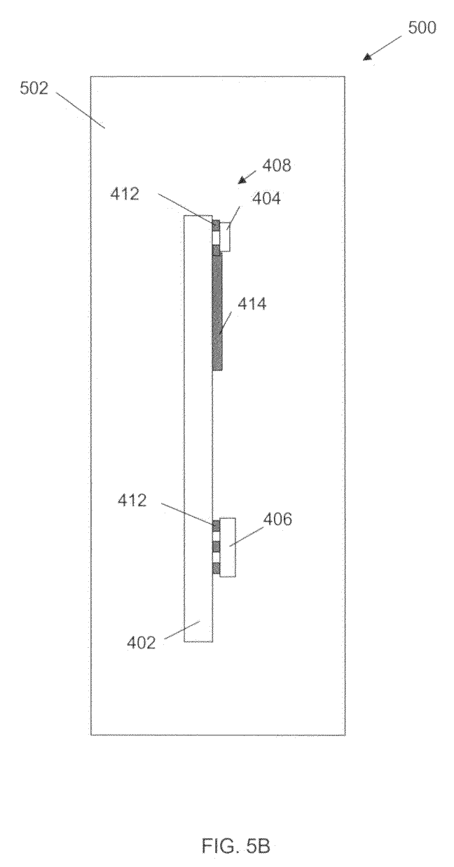

FIG. 6 shows a flowchart 600 providing example steps for assembling an electrical device, according to an embodiment of the present invention. Other structural and operational embodiments will be apparent to persons skilled in the relevant art(s) based on the following discussion. The steps shown in FIG. 6 do not necessarily have to occur in the order shown. The steps of FIG. 6 are described in detail below. FIGS. 7A and 7B show an RFID enabled device at different stages of assembly and are referred to throughout the discussion of flowchart 600.

Flowchart 600 begins with step 602. In step 602, an antenna is provided on a surface of a substrate. For example, in FIG. 7A, electrically conductive material is used to form antenna 414. As shown in FIG. 7A, antenna 414 is formed as a combination of electrical traces 410b and 410c. In an alternate embodiment, the antenna may be included in an integrated circuit package, such as a dual in-line package, ball-grid array, etc., and mounted, or otherwise attached, to the substrate.

In step 604, a land pattern for an electrical circuit is provided. For example, in FIG. 7A, lands pads 412 form land patterns 702 that may be used to couple electrical circuits to substrate 402. The electrical circuit may be a circuit component such as a resistor, capacitor, etc., or may be an electrical circuit with logic processing capabilities such as a microprocessor that is included in an integrated circuit package.

In step 606, the electrical circuit is mounted on the substrate. For example, in FIG. 7B, electrical circuit 406a is mounted onto substrate 402. In an embodiment shown in FIG. 7B, electrical circuit 406a is mounted onto substrate 402 through land pattern 702. In an embodiment where the antenna is formed on the substrate out of electrically conductive material, an electrical circuit that stores an identification code and is configured to respond to interrogations signals may also be mounted onto the substrate. For example, in FIG. 7B, electrical circuit 404 is mounted to substrate 402. Electrical circuit 404 is electrically coupled to antenna 414. In alternate embodiments, electrical circuits may be coupled to substrate in other ways, as would be understood by persons skilled in the relevant art(s).

In an embodiment, mounting electrical components may include soldering. Solder may be deposited on land pads 412 and/or on leads emanating from first electrical circuit 404 and electrical circuits 406 to facilitate soldering.

Electrical circuits 406 are electrically isolated from first antenna 414. Electrical circuit 406 may include a variety of components. For example, in FIG. 7B, electrical circuit 406a may be a microprocessor, electrical circuit 406b may be a memory, and electrical circuit 406c may be an LCD driver.

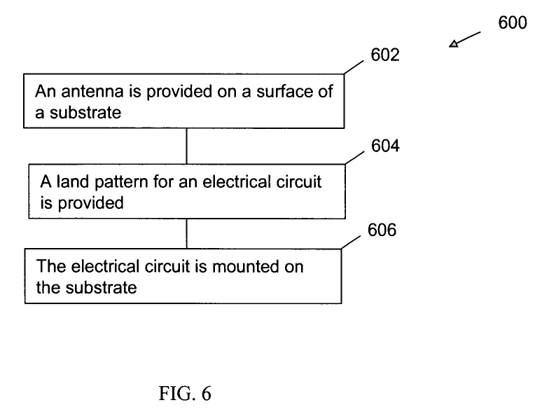

FIGS. 8-11 provide optional additional steps for flowchart 600 shown in FIG. 6. FIG. 8 shows step 802. In step 802, the substrate, the electrical circuit, and the antenna are enclosed in an enclosure. In further embodiments, other electrical circuits may also be enclosed within the enclosure. For example, in FIG. 5A, substrate 402, electrical circuit 404, electrical circuits 406, and antenna 414 are enclosed in enclosure 502. In an embodiment, enclosure 502 is made of a material that is transparent to RF electromagnetic waves such as a plastic.

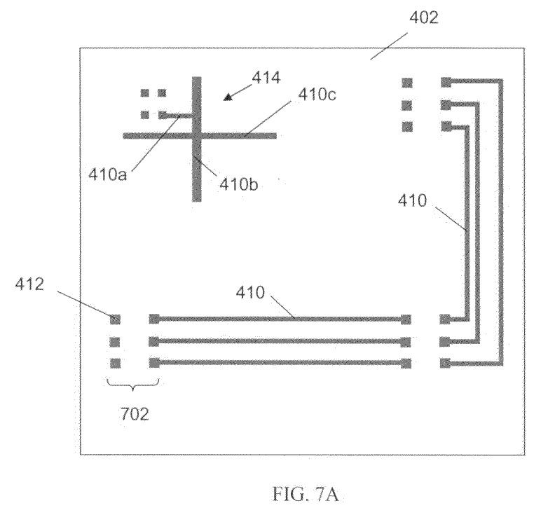

FIG. 9 shows steps 902 and 904. In step 902, a second electrical circuit is mounted to the substrate. For example, in FIG. 7B, electrical circuit 406b may be mounted onto substrate 402.

In step 904, a trace that electrically couples the first electrical circuit to the second electrical circuit is formed. For example, in FIG. 7B, electrical traces 410 electrically couple electrical circuits 406 mounted on substrate 402. Electrical traces 410 are made of an electrically conductive material such as copper or aluminum.

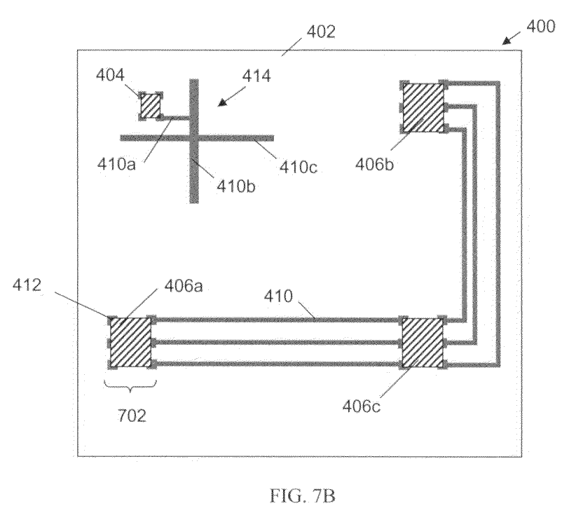

FIG. 10 shows steps 1002 and 1004. In steps 1002 and 1004 the substrate is laid out using a PCB layout tool. In step 1002, the antenna is laid out. In an embodiment, the antenna is made up of a combination of electrical traces.

In step 1004, the land pattern for the electrical circuit to be mounted to the substrate is laid out. The land pattern includes land pads configured to accept electrical circuit to be mounted to the substrate.

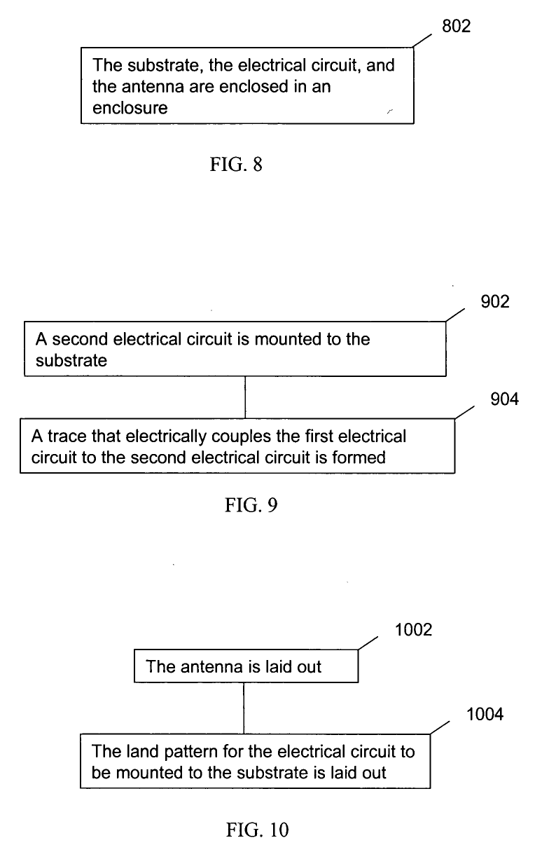

FIG. 11 shows step 1102. In step 1102, a via is formed in the substrate. The via may be used to couple different layers of the substrate together. The via may also be used along with electrical traces to electrically couple electrical circuits mounted on the substrate.

### EXAMPLE RFID ENABLED DEVICE COMMUNICATION EMBODIMENTS

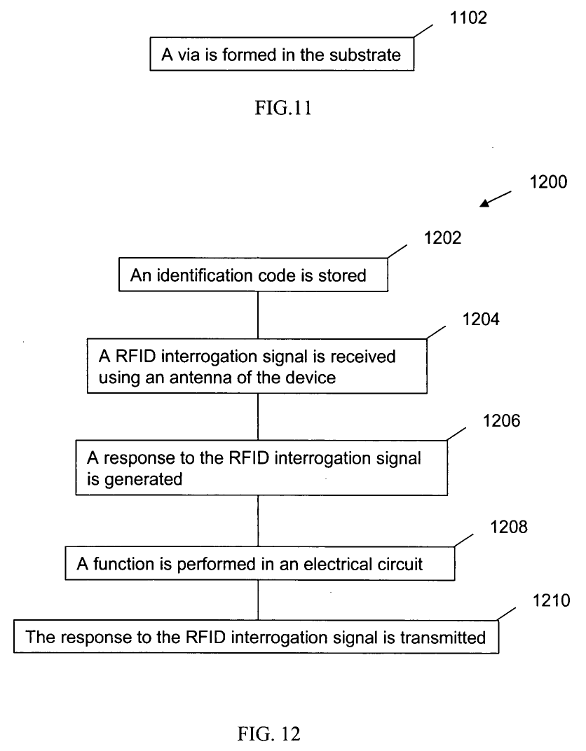

FIG. 12 shows a flowchart 1200 providing example steps for communicating with an RFID enabled electrical device, according to an embodiment of the present invention. Other structural and operational embodiments will be apparent to persons skilled in the relevant art(s) based on the following discussion. The steps shown in FIG. 12 do not necessarily have to occur in the order shown. The steps of FIG. 12 are described in detail below.

Flowchart 1200 begins with step 1202. In step 1202, an identification code is stored. In an embodiment, the identification code is stored on an electrical circuit that is mounted to a substrate of the device. The identification code may identify the device and is accessible to an RFID reader according to an RFID communication protocol. In a further embodiment, the electrical circuit may be mounted onto the substrate. In an alternate embodiment, the electrical circuit may be included in an integrated circuit package that also includes an antenna.

In step 1204, an RFID interrogation signal is received using an antenna of the device.

In step 1206, a response to the RFID interrogation signal is generated. The response may include the identification code. The response may also identify an electrical circuit mounted on the substrate. In another embodiment, the response may indicate that the device needs maintenance and/or may provide other information. In the embodiment where the identification code is stored on an electrical circuit, the electrical circuit may be configured to receive the interrogation signal and generate the response.

In step 1208, a function is performed in an electrical circuit. The electrical circuit may be electrically isolated from the antenna. The function may be a variety of different operations such as processing data, performing a calculation, timing an event, etc.

In step 1210, the response to the RFID interrogation signal is transmitted. In an embodiment, the response is transmitted by backscattering the interrogation signal.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method of assembling a radio frequency identification (RFID) enabled electrical device, comprising:
providing an antenna on a surface of a substrate;
providing a land pattern for an electrical circuit; and
mounting the electrical circuit on the substrate, wherein the electrical circuit is electrically isolated from the antenna.

2. The method of claim 1, further comprising:
enclosing the substrate, the antenna, and the electrical circuit in an enclosure.

3. The method of claim 1, wherein mounting the electrical circuit comprises:
soldering the electrical circuit to the substrate.

4. The method of claim 1, wherein the mounting step further comprises:
mounting a second electrical circuit to the substrate.

5. The method of claim 4, further comprising:
forming a trace that electrically couples the first electrical circuit to the second electrical circuit.

6. The method of claim 1, further comprising:
forming a via in the substrate.

7. The method of claim 1, further comprising:
laying out the substrate using a printed circuit board (PCB) development tool, including:
laying out the antenna, and
laying out the land pattern for the electrical circuit to be mounted to the substrate.

8. The method of claim 7, wherein laying out the antenna comprises laying out a plurality of traces, wherein the plurality of traces are configured to operate as an antenna.

9. The method of claim 1, wherein an integrated circuit package comprises the antenna, wherein providing the antenna on the surface of the substrate includes mounting the integrated circuit package on the substrate.

10. An RFID enabled electrical device, comprising:
a substrate;
an antenna; and
an electrical circuit mounted on the substrate that is electrically isolated from the antenna.

11. The device of claim 10, further comprising:
an enclosure, wherein the substrate, the antenna, and the electrical circuit, are located within the enclosure.

12. The device of claim 10, wherein the electrical circuit comprises a surface-mount device.

13. The device of claim 10, wherein the electrical circuit comprises a microprocessor.

14. The device of claim 10, wherein the enclosure comprises a material that is transparent to RF electromagnetic waves.

15. The device of claim 14, wherein the material is a plastic.

16. The device of claim 10, further comprising an integrated circuit package, wherein the antenna is located within the integrated circuit package.

17. The device of claim 16, wherein the integrated circuit package further comprises a second electrical circuit, wherein the electrical circuit stores an identification code and is configured to provide a response to an RFID interrogation signal, wherein the response includes the identification code.

18. The device of claim 10, wherein the identification code identifies the device.

19. The device of claim 10, wherein the substrate is resin or a flex-tape substrate.

20. The device of claim 10, wherein the antenna is a dipole antenna, loop antenna, dual-dipole antenna, or patch antenna.

21. The device of claim 10, further comprising:
a second electrical circuit; and
a trace, wherein the trace electrically couples the first electrical circuit to the second electrical circuit.

22. The device of claim 10, wherein the substrate is a printed circuit board (PCB).

23. A method of communicating with an RFID enabled device comprising:
storing an identification code;
receiving an RFID interrogation signal with an antenna of the device;
generating a response to the RFID interrogation signal, wherein the response includes the identification code;
performing a function in an electrical circuit mounted on the substrate and electrically isolated from the antenna; and
transmitting the response to the RFID interrogation signal.

24. The method of claim 23, wherein the storing step comprises:
storing an identification code that identifies the device.

25. The method of claim 23, wherein the storing step comprises:
storing an identification code that identifies the electrical circuit.

26. The method of claim 23, wherein generating step further comprises:
generating a response that indicates that the device needs maintenance.

26. The method of claim 23, wherein the transmitting step comprises:
backscattering the RFID interrogation signal.
